(19) United States
(12) Patent Application Publication
(10) Pub. No.: US 2011/0266941 A1
(43) Pub. Date: Nov. 3, 2011

(54) Cold Cathode Electron Tube, Its Manufacturing Process and Use Thereof for a Display Screen

(75) Inventors: Gilles Tocu, Congis sur Therouanne (FR); Yves Pontaillier, Mennecy (FR); Jean-Claude Goubert, Le Gruau du Roi (FR)

(73) Assignee: NEWSTEP, Tremblay en France (FR)

(21) Appl. No.: 13/123,985

(22) PCT Filed: Sep. 7, 2009
(86) PCT No.: PCT/FR09/51683

§ 371 Date: May 26, 2011

(30) Foreign Application Priority Data
Oct. 15, 2008 (FR) 0856984

(51) Int. Cl. H01J 31/15; H01J 9/26; H01J 31/08

(52) U.S. Cl. 313/400; 313/399; 445/30

(57) ABSTRACT

A process for manufacturing a cathodoluminescent capsule including at least one envelope, a cold cathode, an anode and a grid.

The process comprises at least the steps of:
depositing luminophore and reflective layers on an internal wall;
depositing a conductive layer at least contacting the luminophore layer;
providing a cap having a tube including at least three metal conductors, each being respectively welded to the anode, cathode and grid;
assembling the cap with the envelope so as to form the capsule, the anode being in contact with the conductive layer and the luminophore layer opposed to the cathode;
vacuuming the capsule via the tube;
sealing the capsule by closing an end of the cap tube.

### FIELD

The present invention generally relates to the field of cold cathode electron tubes.

### BACKGROUND

More particularly, the invention relates to a manufacturing process for a cathodoluminescent capsule including at least a tight, closable envelope, under vacuum, a cold cathode emitting electrons by field effect, an anode and a control grid, the envelope being at least formed of a first internal wall receiving the electrons.

The large conventional advertising panels (of 3 meters and more) composed of a matrix of cathode ray tubes (or CRT) are heavy, thick and need to operate with very high voltages, and those based on LEDs (or light-emitting diodes), although exhibiting high image quality, have the disadvantage of requiring a number of bulky and expensive control and cooling elements.

In this context, the present invention aims at providing, in particular, a cathodoluminescent capsule as well as its manufacturing process freed from at least one of the aforementioned limitations, making it possible to provide big sized display panels (for example more than 3 meter-sided).

In particular, the aim of the invention is to reduce the size of the electron tubes, as well as the heating thereof, and to provide a suitable, non complex manufacturing process.

In particular, the invention provides a cathodoluminescent capsule operable at low voltages (for example between 5 and 7 kV), using preferably a cold source, having preferably millimeteric dimensions and optimizing the image quality.

For example, each capsule may constitute a pixel of a visualization panel which may be made up of hundreds of thousands of such capsules, making it possible to obtain a high quality video image. Taken individually, the capsules can also be applied to lighting or back-lighting systems.

### SUMMARY

These and other objectives are achieved by the invention whose object is a manufacturing process of a cathodoluminescent capsule including at least an envelope, a cold cathode emitting electrons through field effect, an anode and a control grid, the envelope being at least made of a first internal wall for receiving the electrons and disposed facing the cathode.

The process comprises at least the steps of:
depositing a luminophore layer and a reflective layer over at least the first internal wall, the luminophore layer located between the first internal wall and the reflective layer;
depositing a conductive layer over at least a portion of a second internal wall adjacent to the first internal wall, the conductive layer being at least in contact with the luminophore layer;
providing a cap carrying at least the anode, at the cathode and the control grid, the cap being further provided with an open tube;
assembling the cap with the envelope to close and form the capsule, the anode being brought into contact with the conductive layer and the luminophore layer being disposed opposed to the cathode;
vacuuming the capsule via the cap tube; and
sealing the capsule by closing the cap tube.

According to an embodiment, the envelope and the cap can be made from glass, and the cap can be made through at least the steps of:
pressing and melting glass around three metal conductors; and
welding the anode, the cathode and the control grid over the first, second and third metal conductors, respectively.

For example, the assembly step comprises at least steps of:
heating part of the cap glass and part of the envelope glass until melting;
positioning and contacting the melting parts of the cap glass and the envelope glass with each other;
rotating the cap and the envelope to mix both melting parts;
overall cooling to ensure a tight sealing of the cap with the envelope, for example with a stabilizing processing.

Preferably, vacuuming the capsule is a secondary vacuuming.

Advantageously, the sealing of the cap tube is carried out by melting the external end of the cap tube over a length of few millimeters to plug the tube.

Another object of the invention is a cathodoluminescent capsule composed of at least an envelope, a cold cathode emitting electrons by field effect, an anode and a control grid, the envelope being at least formed of a first internal wall for receiving electrons emitted by the cold cathode. The capsule further comprises:
a luminophore layer and a reflective layer over the first internal wall, the luminophore layer being inserted between the first internal wall and the reflective layer, the cathode being preferably disposed facing the reflective layer;
a conductive layer over at least part of a second internal wall adjacent to the first wall, providing at least an electric connection between the anode, the luminophore layer and the reflective layer;
a cap including at least first, second and third metal conductors respectively welded to the anode, cathode and control grid; and
the cathode is made from at least a carbon nanotube and is a cold cathode of nanometric size.

The cold cathode is for example made from at least a carbon nanotube, or from carbon fibers, or from a crystalline form carbon film.

Preferably, the control grid incorporates a getter advantageously allowing holding the capsule under vacuum.

According to an embodiment, the second internal wall of the envelope can be tubular, with a thickness at most equal to 1 millimeter, a diameter and a length ranging between 1 millimeter and 10 millimeters.

Another object of the invention is a display device comprising at least a plurality of individual display elements divided into a matrix over a substrate, and a set of control means for controlling such individual display elements, each individual display element being a cathodoluminescent capsule as described above.

### DRAWINGS

These and other objects, characteristics and advantages of the invention will become more apparent from the following description of a preferred embodiment thereof, made on a non limitative basis with reference to the accompanying drawings in which:

FIG. 1 represents a schematic cross-section of a cathodoluminescent capsule according to a particular embodiment of the invention; and

FIG. 2 represents the main steps of a manufacturing process according to a particular embodiment of the invention.

### DETAILED DESCRIPTION

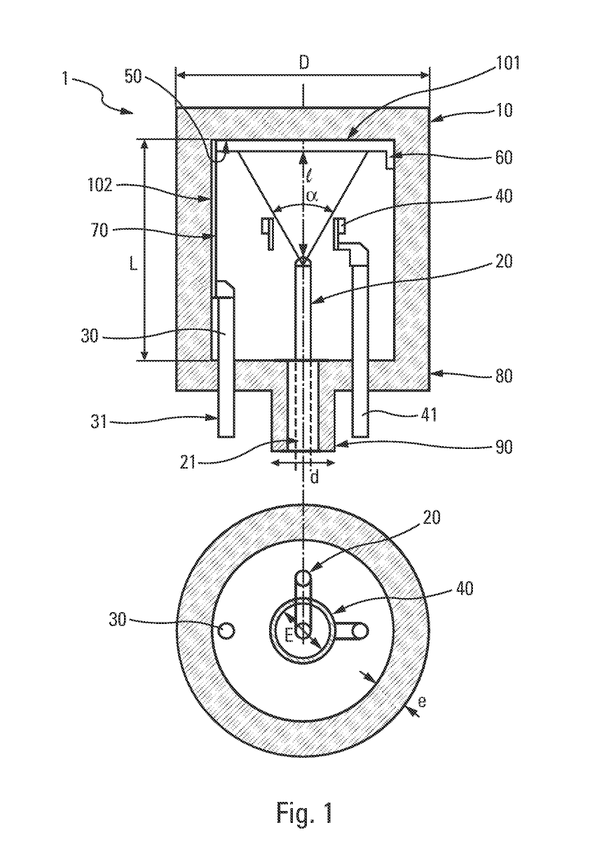

According to a particular embodiment of the invention, cathodoluminescent capsule 1 (or cold cathode electron tube or microtube), of FIG. 1, particularly comprises an envelope 10 sealed with a cap 80, a cold cathode 20 (or source) emitting electrons by field effect, an anode 30 and a control grid 40 (or control electrode).

Cold cathode 20 can be made up of carbon nanotubes and can have a structure as disclosed in application FR 2,857,379. The cathode can also be a metal tip such as for example nickel or tantalum or Kovar, on which carbon nanotubes (or CNT) are grown.

Control grid 40, preferably made from a metal part and having for example an annular or lattice form, makes it possible to control the electron emission by controlling the electric field in the vicinity of cathode 20. Preferably, the grid is positioned in a symmetrical way with respect to the cathode axis.

For example, envelope 10 (or bulb) made from transparent glass, such as glasses typically used for cathode ray tubes, exhibits a tubular form of for example a diameter D of 8 millimeters, a length L of 8 millimeters, and a thickness e of 1 millimeter. Envelope 10, preferably open, is for example made of a first internal wall 101 for receiving the electrons emitted by the cold cathode 20.

Cap 80, preferably made from glass, comprises for example first, second and third metal conductors respectively welded to the anode, cathode and control grid.

The capsule can further comprise:
a luminophore layer 50, a material emitting light when it receives electrons of sufficient energy (for example phosphor), on the first internal wall 101, the cathode being disposed opposed to the luminophore layer 50;
a reflective layer 60 (for example of aluminum or silver) deposited such that luminophore layer 50 be inserted between said first internal wall 101 and this reflective layer 60, the advantage of this reflective layer being that it intensifies the light emitted by the phosphor; and
a conductive layer 70 (for example of graphite or carbon) on a second internal wall 102 adjacent to the first internal wall 101, securing at least the contact between anode 30 and luminophore layer 50.

Preferably, the luminophore 50 and reflective 60 layers are deposited on the entire surface of the first internal wall 101.

This capsule can therefore emit a constant light of red, green or blue color by phosphor excitation using electron beams generated by a carbon nanotube-based transmitter.

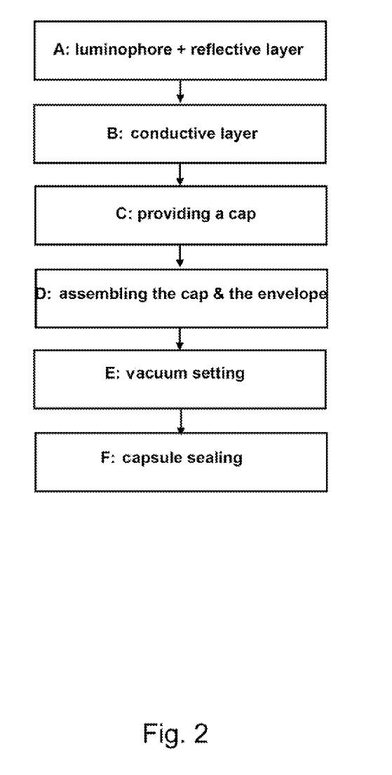

This cathodoluminescent capsule 1 can be made according to a particular manufacturing process, including in particular the following steps of (FIG. 2):

A: depositing a luminophore layer 50 and a reflective layer 60 on the first internal wall 101, the luminophore layer 50 being inserted between the first internal wall 101 and the reflective layer 60. For example, the phosphorus layer may be deposited using the methods employed in manufacturing traditional cathode ray tube displays.

B: depositing a conductive layer 70 on a second internal wall 102 adjacent to the first internal wall 101, this conductive layer 70 being at least in contact with the luminophore layer 50;

The envelope made this way can be cleaned and stored properly until the final assembly.

C: preparing a cap 80 which is particularly useful for securing the passage of the various operating voltages. Cap 80 comprises at least first, second and third metal conductors 21, 31, 41 respectively welded to anode 30, cathode 20 and control grid 40. Preferably, cap 80 is obtained by pressing and melting glass around the metal conductors whose composition allows for a glass-metal sealing. Cap 80 is further provided with an opening onto which an open tube 90 is welded (preferably made from glass as well) making it possible to vacuum the capsule. All the electrodes (cathode 20, anode 30 and control grid 40) are preferably laser welded onto the connectors of cap 80 in order to maintain a determined position therebetween. Preferably, the position of the cathode connector is shifted with respect to the position of the cap tube 90.

D: assembling cap 80 with envelope 10 to form the capsule 1, the anode 30 being brought into contact with the conductive layer 70 and the cathode 20 being disposed opposed to the luminophore layer 50. For example, a portion of the glass of cap 80 and a portion of the glass of the envelope are heated to melt. These melted portions are then positioned and contacted between each other, then by rotating the cap and the envelope it is possible to mix these two melted portions. An overall cooling makes it possible to obtain a tight sealing between the cap and the envelope. The assembly must further secure a precise position of the transmitter facing the phosphors.

E: then placing the capsule on a vacuum pump via tube 90 of the cap 80. The vacuum may be a secondary vacuum (for example of about 10⁻⁸ torr).

F: when the secondary vacuum is reached, the operation of sealing (or closing) the capsule is carried out. For example, this operation is performed by melting an end of tube 90 over a length of few millimeters which, upon retraction, will plug and maintain the capsule under vacuum.

Control grid 40 can incorporate an active getter. This getter (or degasser) is a substance making it possible to maintain a good level of vacuum by absorbing the residual gases which would have otherwise remained in the capsule after sealing of the cap tube 90. In addition, the getter allows holding the level of vacuum such as after the sealing operation.

An operation of checking the efficient performance of the capsule can then be carried out. During this operation all the performance characteristics and the major operating parameters of the capsule could be adjusted.

Thus made, the cathodoluminescent capsules could be used in the production of a display device. Preferably, this display device comprises a plurality of such cathodoluminescent capsules divided into a matrix over a substrate, each capsule preferably representing an individual display element (or pixel). The substrate can further comprise a set of control means for controlling such capsules. The association of three various capsules of red, green and blue colors, will make it possible to generate a color image and to achieve a big sized display panel (for example of more than 3 meters) exhibiting high quality video image. In the case where the screen has a size higher than 5.8 meters for example, it will exhibit a definition of the VGA type (Video Graphics Array), when seen at a sufficient distance for the visual resolution to be higher with respect to the size of the capsules. The substrate could be a flexible polymer to provide the panel with high flexibility during use. These capsules could be used for producing advertising display boards, big screens for movie theaters, sporting and airport information. The size of each capsule can be optimized to ensure an optimum matrix assembly of the light points or a correct balance of the white (or gamut), for example with a larger size for the capsules emitting green light.

Preferably, the phosphors are designed to operate under low voltages (preferably less than 10 Kv). The power supply of the capsule could be made using a voltage between 2 to 5 Kv to provide a current of at least 100 μA to energize the phosphors.

For instance, the electronic characteristics of this capsule can be:
anode voltage: 2 to 5 Kv
emission density: 1 A/cm² (for an emission from a carbon nanotube based cold cathode)

The beam thus generated makes it possible to provide via the phosphors a light intensity higher than 500 cd/m².

Advantageously, the electron beam emitted from the cathode towards the wall forms an angle α preferably between 10 and 20 degrees, for example 15 degrees.

These characteristics can also permit sizing the cathode, the control grid, as well as the distances between the cathode, the control grid and the phosphor layer.

Advantageously, the dimensions of the capsule can be as follows:
diameter d of the cap tube 90: 3 mm≦d≦4 mm
thickness e of envelope 10: 1 mm≦e≦2 mm
diameter D of envelope 10: 6 mm≦D≦8 mm
length L of envelope 10: 5 mm≦L≦6 mm
distance 1 between cathode 20 and reflective layer 60: 4 mm≦1≦6 mm
diameter E of the control grid: 0.2 mm≦E≦0.4 mm

For example, the cap connectors 21, 31, 41 can be positioned on a diameter from 3 to 4 mm and be located respectively at 0°, 90° and 180° from the axis X of the capsule.

The distance from the cathode connector 21 with respect to tube 90 ranges for example between 0.5 and 1 mm.

For example, the thicknesses of the luminophore, reflective and conductive layers 50, 60, 70 are respectively of 0.2 mm, 0.2 mm and 0.3 mm.

For example, the getter is made from porous barium metal and can be laser welded onto one of the walls of grid 40 in the shade of the electron beam path.

1. A process for manufacturing a cathodoluminescent capsule including at least an envelope, a cold cathode emitting electrons by field effect, an anode and a control grid, the envelope being at least formed of a first internal wall for receiving the electrons and being disposed fading the cathode, said process including at least the steps of:
depositing a luminophore layer and a reflective layer at least over the first internal wall, the luminophore layer being located between the first wall and the reflective layer;
providing a cap carrying at least the anode, to the cathode and the control grid, the cap being further provided with an open tube;
assembling the cap with the envelope so as to close and form the capsule, the luminophore layer being disposed in opposition to the cathode;
vacuuming the capsule via the cap tube; and
sealing the capsule by closing the cap tube, characterized in that it further comprises the step of depositing a conductive layer over at least a portion of a second internal wall adjacent to the first internal wall, the conductive layer contacting at least the luminophore layer, and in that the anode is brought into contact with the conductive layer.

2. The process according to claim 1, wherein the envelope and the cap are made from glass, and that the provision of the cap comprises at least the steps of:
pressing and melting the glass around three metal conductors; and
welding the anode, the cathode and the control grid over respectively the first, second and the third conductors.

3. The process according to claim 1, wherein the step of assembling comprises at least steps of:
heating until melting part of the cap glass and part of the envelope glass;
positioning and contacting the melting parts of the cap glass and of the envelope glass with each other;
rotating the cap and the envelope to mix the two melting parts; and
overall cooling to secure a tight sealing between the cap and the envelope.

4. The process according to claim 1, wherein the vacuuming of the capsule is a secondary vacuuming.

5. The process according to claim 1, wherein the sealing of the cap tube is carried out by melting the external end of the cap tube over a length of few millimeters to plug the tube.

6. A cathodoluminescent capsule including at least an envelope, a cold cathode emitting electrons by field effect, an anode and a control grid, the envelope being at least formed of a first internal wall for receiving the electrons emitted by the cold cathode, said capsule further including:
a luminophore layer and a reflective layer on the first internal wall, the luminophore layer being inserted between the first internal wall and the reflective layer, the cathode being disposed facing the reflective layer;
a cap including at least first, second and third metal conductors respectively welded to the anode, cathode and control grid,
characterized in that it comprises a conductive layer over at least part of a second internal wall adjacent to the first internal wall, and providing at least an electric connection between the anode, the luminophore layer and the reflective layer.

7. The capsule according to claim 6, wherein the cold cathode is formed of at least one of carbon nanotubes, carbon fibers or a crystalline-form carbon film.

8. The capsule according to claim 6, wherein the control grid incorporates a getter.

9. The capsule according to claim 6, wherein the second internal wall of the envelope is tubular and exhibits a thickness at most equal to 1 millimeter, a diameter and a length ranging between 1 millimeter and 10 millimeters.

10. A display device including at least a plurality of individual display elements divided into a matrix over a substrate, and a set of control means for controlling such individual display elements,
wherein each individual display element is a cathodoluminescent capsule according to claim 6.
